(19) United States
(12) Patent Application Publication
(10) Pub. No.: US 2009/0276339 A1
(43) Pub. Date: Nov. 5, 2009

(54) RECEIVING CHECK AND BALANCE SYSTEM

(75) Inventors: Chinchun Low, Singapore (SG); Keelay Chuah, Singapore (SG); Vimalraj Thanaraj, Singapore (SG); Tinking Ang, Singapore (SG)

Correspondence Address: Shumaker & Sieffert, P.A., 1625 Radio Drive, Suite 300, Woodbury, MN, 55125, US

(73) Assignee: SEAGATE TECHNOLOGY LLC, Scotts Valley, CA (US)

(21) Appl. No.: 12/112,160

(22) Filed: Apr. 30, 2008

(51) Int. Cl. G06Q 10/00

(52) U.S. Cl. 705/29

(57) ABSTRACT

A method for managing and fulfilling inventory requests is provided. Material orders originating from a customer are received at a material hub. Each order originates from a customer and contains a request for parts. The material orders are aggregated into a consolidated order reflecting an aggregate quantity of each part ordered. A material request list is generated identifying a total number of each part to be delivered to the location. The parts are retrieving from inventory and delivered to the location. Parts can be contained in a package which includes a scannable identifier for encoding a type of the part and a quantity of the part contained in the package. Prior to delivery, the identifier can be scanned and the quantity of each part being delivered is determined. The quantity of parts being delivered is compared to the number of parts identified by the materials request list.

### BACKGROUND

In a manufacturing or other assembly environment, the availability of parts inventory and processing of requests for those parts is important to the efficiency and capability of the environment. Operators at the manufacturer request materials from a materials hub, such as a Vendor Owned Inventory (VMI) hub, as they are needed or anticipated to be needed. In contexts where demand is difficult to forecast the best one can do is to quickly respond to observed demand.

FIG. 1 illustrates a prior art process 100 by which inventory orders are processed. Customers 110 send out material requests 130 to the vendor operated inventory hub 120 (e.g., VMI hub). The hub 120 operator will process the requests and deliver the materials 140 to the customer along with an electronic delivery order document. The receiving store of the customer 110 will inspect and count the physical material, and acknowledged the delivery order document to complete the fulfillment process.

Many operations use a Kanban system that attempts Just-In-Time (“JIT”) delivery of materials to the requesting party. Kanban typically uses cards to signal the need for an item. However, other devices such as plastic markers or an empty part-transport trolley can also be used to trigger the movement, production, or supply of a unit in a factory.

Kanban acts as a demand signal which immediately propagates through the entire chain. “Push” systems often encounter serious difficulties when demand forecasts turn out to be inaccurate. The need is to ‘quickly’ respond. Where the response cannot be quick enough, e.g. significant lost sales/downstream production, then stock building may be appropriate by issuing more kanban.

A simple example of the Kanban system implementation might be a “three bin system” for the brought out parts (where there is no in-house manufacturing)—one bin on the factory floor, one bin in the factory store and one bin at the suppliers' store. The bins usually have a removable card that contains the product details and other relevant information—the Kanban card. When the bin on the shop floor is empty, the bin and Kanban card are returned to the store. The store then replaces the bin on the factory floor with a full bin which also contains a Kanban card. The store then contacts the supplier and returns the now empty bin with its Kanban card. The suppliers inbound product bin with its Kanban card is then delivered into the factory store completing the final step to the system.

Kanban, and other inventory solutions, do no provide a way to verify that the quantity of materials ordered has been properly received in the system and validate that the order has been fulfilled correctly. As operations expand, tracking and verification of order fulfillment becomes a greater concern and can have a more significant impact on efficiency and productivity of manufacturing operations.

Furthermore, in traditional inventory solutions, supply hub operators are required to make many deliveries and thus lose time while processing individual requests and delivering materials in response to the request.

What is needed in the art is a way to aggregate materials requests and/or the delivery of materials in response to requests. Further, an accounting and verification that the requests have been correctly processes and the correct items delivered is also desired.

### SUMMARY OF THE INVENTION

In accordance with one aspect of the invention, a method for managing and fulfilling inventory requests is provided. Material orders originating from a customer are received at a material hub. Each order originates from a customer and contains a request for parts. The material orders are aggregated into a consolidated order reflecting an aggregate quantity of each respective part ordered. A material request list is generated identifying a total number of each part to be delivered to the location. The parts identified in the consolidated order are retrieving from inventory and delivered to the location.

In accordance with a further aspect of the present invention, parts can be contained in a package which includes a scannable identifier for encoding a type of the part and a quantity of the part contained in the package. Prior to delivering the parts to the customer location, the identifier is scanned and the quantity of each part being delivered is determined. The quantity of parts being delivered is compared to the number of parts identified by the materials request list. Optionally, a discrepancy report can be produced which identifies inconsistencies between the quantity of each part delivered and the total number of each part specified by the materials request list.

### BRIEF DESCRIPTION OF THE DRAWINGS

The foregoing and other features of the present invention will be more readily apparent from the following detailed description and drawings of the illustrative embodiments of the invention wherein like reference numbers refer to similar elements throughout the views and in which:

FIG. 1 illustrates a flow of messages and materials in a system of inventory management known in the art;

FIG. 2 illustrates a flow of messages and materials in accordance with an embodiment of the present invention;

FIG. 3 illustrates an exemplary scannable identifier in accordance with an embodiment of the present invention; and

FIG. 4 illustrates an exemplary discrepancy list in accordance with an embodiment of the present invention.

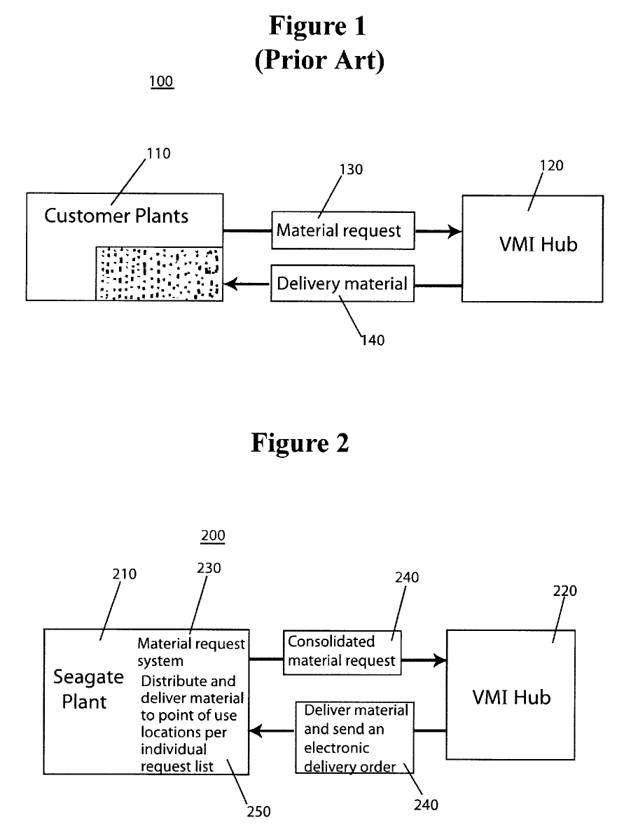

### DETAILED DESCRIPTION

This present invention is related to order processing and inventory management, and is more particularly related to the aggregation of orders for processing and verification of fulfillment of orders to increase efficiency.

With reference to the drawings, process 200 of FIG. 2 illustrates the flow of messages and materials between a factory 210 (e.g., Seagate Plant) and the inventory hub 220 (e.g., VMI Hub) in accordance with an embodiment of the present invention.

The factory 210, or other manufacturing or assembly environment, can request various parts and materials to carry out its manufacturing process. These material requests can be material orders or part orders. Material requests can be generated at various workstations through the factory 210. Each workstation can request parts in response to various conditions. For example parts can be requested on a periodic basis, in anticipation of use, or when supplies reach a configurable inventory threshold.

Material requests can be processed through a material request system 230 which aggregates or consolidates material requests from the various workstations in the factory 210. For example, if a particular part is requests by three locations, the part will appear only once in the aggregated material request. The aggregated material requests can contain requests for various types of parts supplied by the inventory hub 220. Further, for each type of part, the aggregate request can specify the sum of parts ordered by the material requests that are being aggregated. That is, if a first location requests five of a particular part, and a second location requests three of the same part, the aggregate material request will reflect a request for eight of the particular part. The material request system 230 can also generate individual material requests lists for the various locations.

While, the material request system 230 is illustrated in FIG. 2 as located at the factory 210, it would be understood by one of ordinary skill in the art that the material request system 230 can be located at the inventory hub 220 or offsite.

The aggregated material request is transmitted to the inventory hub 220 and received at step 240. The aggregated material order can be transmitted electronically, by telephone, or by other known methods of communication. Electronic transmission can be by email, web protocol, other standard protocol, or by proprietary protocol.

The parts identified by the aggregated material order are retrieved at the inventory hub 220 in the quantities specified by the aggregated material order. Retrieval can be performed manually by operators of the inventory hub 220. Alternatively, because the aggregated material order can be transmitted electronically, retrieval can be accomplished by an automated system, such as a robotic system.

Once retrieved, the parts retrieved can be delivered to the factory 210. Optionally, a delivery order can be included with the parts. The delivered parts can be processed at a distribution point 250 of the factory 210 before being delivered to the requesting location.

Aggregation of materials orders can be scheduled and performed at configurable intervals. That is, material orders received at the material request system 230 can be stored and periodically aggregated to generate the materials order list. The schedule according to which material orders are aggregated can be based on various criteria, including predetermined time intervals, when the size or number of material request orders reaches a predetermined threshold, or a combination of factors. Alternatively, material orders can be aggregated at the material request system 230 as they are received, but transmitted periodically to the inventory hub 220. Similarly, the inventory hub can periodically deliver the materials ordered.

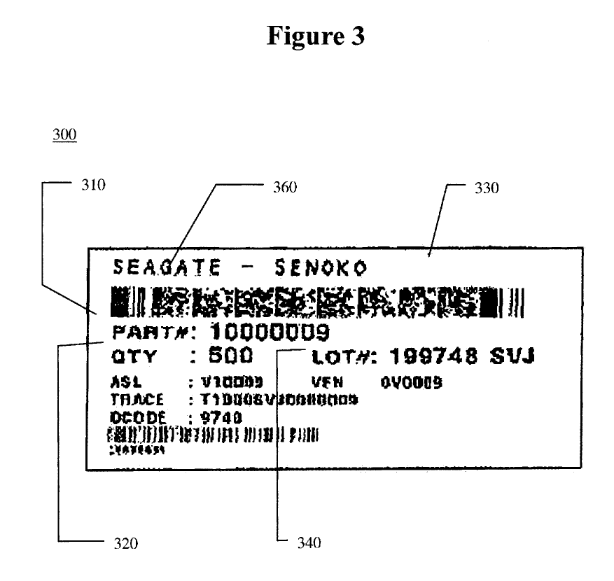

At the inventory hub 220, parts can be stored in bulk containers or packages. Each package can be associated with an identifier. Preferably the identifier is scannable so as to automate the processing of the package. FIG. 3 illustrates an exemplary scannable identifier 300. The identifier 300 can specify the part number 310 the quantity of the part 320 contained in the package, and the lot number 340 of the parts contained in the package. Additional information can be included in the identifier 300 such as the operator of the inventory hub 360.

The identifier 300 illustrated in FIG. 3 includes a scannable bar code 330 that encodes the information necessary for processing. Preferably, the bar code 330 encodes the part number 310 and the quantity 320. It would be understood by one of ordinary skill in the art that other types of scannable encoding can be included in the identifier 300. For example, the identifier 300 can include an RFID tag or Optical Characters that can be scanned and read by a computer.

Scannable identifiers support automated processing of the inventory requests. For example, an aggregated material request can be retrieved by inputting the quantity of each desired part. As parts are retrieved the identifier 300 can be scanned and recorded. A tally of the retrieved parts can be maintained at the inventory hub 220 to ensure that the correct number of each part is retrieved. Further, as the parts are delivered to the requesting location at the factory 210, the identifier 300 of each package delivered can be scanned. The quantity delivered can then be compared with the number of parts requested by the particular location.

Encoding the lot umber 340 in the scannable identifier 300 enables the user to determine if the parts being delivered are part of a lot which has been marked for various reasons. For example, a lot may be marked as being of inadequate quality, as determined by quality control tests. When bar code 330 is scanned, the lot number can be extracted and compared against a database of marked lots. If the lot number is marked, the user can be notified that this package of parts should not be delivered.

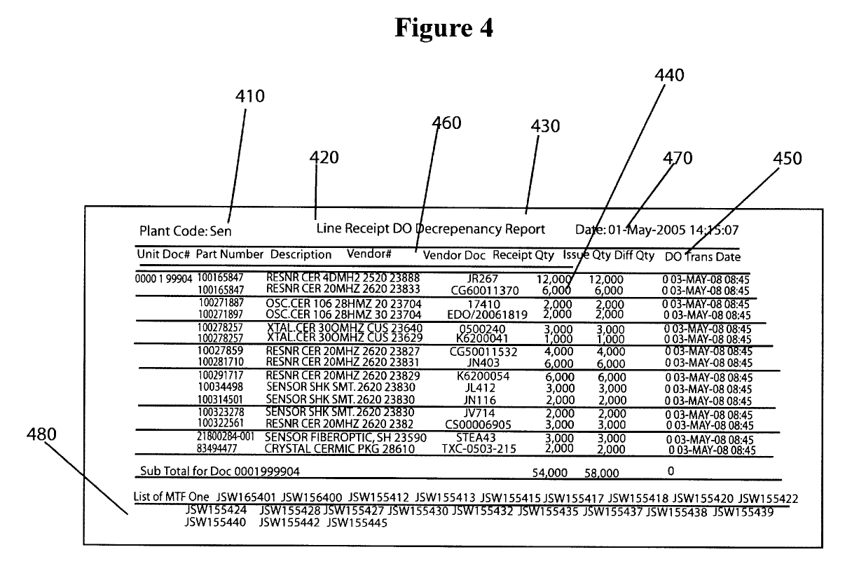

Scanning the identifier 300 further enables the automated creation of a discrepancy report which identifies inconsistencies between the quantity of each part delivered to a location and the total number of parts requested by the location. FIG. 4 illustrates an exemplary discrepancy list 400 created in accordance with an embodiment of the present invention.

Discrepancy list 400 preferably includes various information about the requested parts and parts delivered. The discrepancy list 400 can identify each of the part numbers 410 ordered and delivered. A description 420 and vendor information 460 can also be included. The discrepancy list 400 preferably identifies the requested quantity 430, the delivered quantity 440 and difference 470 between the requested and delivered quantity. Optionally, the discrepancy list 400 includes a timestamp 450 of the transaction. Further, the discrepancy list 400 can include a subtotal 480 of parts ordered, delivered and any discrepancies.

If the discrepancy list 400 indicates that the quantity distributed to all the locations does not match the delivery order, the inventory hub 220 operator can resolve the discrepancies before proceeding to perform receipt transactions.

The above description is presented to enable a person skilled in the art to make and use the invention, and is provided in the context of a particular application and its requirements. The entire disclosure of the patents and publications referred in this application are hereby incorporated herein by reference. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. The implementations described above and other implementations are within the scope of the following claims.

We claim:

1. A method for managing and fulfilling inventory requests, comprising:
receiving a plurality of material orders, each order originating from a customer associated with a respective location and containing at least one part, each part associated with a respective quantity;
aggregating two or more of the plurality of orders into a consolidated order reflecting an aggregate quantity of the respective quantity associated with each part of the two or more aggregated orders;
generating a materials request list for each respective location associated with the two or more aggregated orders, the materials request list identifying a total number of each part to be delivered to the respective location;
retrieving from inventory the aggregate quantity of each part identified in the consolidated order; and
delivering the total number of each retrieved part to the requesting respective location.

2. The method of claim 1, wherein one or more parts are contained in a package and each package includes a scannable identifier encoding a part-type and a quantity of the part contained in the package, the method comprising the further steps of:
scanning each package identifier prior to delivery to the respective location;
determining a quantity of each scanned part that is delivered to the respective location; and
comparing the quantity delivered of each scanned part to the total number of each part to be delivered to the respective location identified by the materials request list.

3. The method of claim 2, further comprising:
producing a discrepancy report identifying inconsistencies between the quantity of each part delivered and the total number of each part to be delivered according to the materials request list for each respective location.

4. The method of claim 2, wherein the scannable identifier comprises a bar code.

5. The method of claim 2, wherein the scannable identifier comprises an RFID tag.

6. The method of claim 3, further comprising the step of resolving the inconsistencies identified in the discrepancy report.

7. The method of claim 1, wherein the receiving step is performed based on a predetermined schedule.

8. The method of claim 1, wherein the aggregation step is performed based on a predetermined schedule.

9. The method of claim 1, wherein each part is associated with a scannable identifier encoding manufacturing information concerning the part, the method comprising the further steps of:
scanning the identifier associated with each part prior to delivery to the respective location; and
determining if manufacturing information satisfies a part alert.

10. A system for managing and fulfilling inventory requests, comprising:
a plurality of material orders, each order originating from a customer associated with a respective location and containing at least one part, each part having a part-type and associated with a respective quantity;
a database configured to store the plurality of material orders;
a consolidated order reflecting an aggregate quantity of the respective quantity of each part of the two or more aggregated orders;
a materials request list for each location associated with the two or more aggregated orders, the materials request list identifying a total-quantity of each part-type to be delivered to the respective location;
a computer including a processor, network adaptor, and computer readable medium, the computer readable medium configured to
receive the plurality of material orders;
aggregate the two or more of the plurality of orders into the consolidated order; and
generate the materials request list.

11. The system of claim 10, further comprising
a package containing one or more parts;
a scannable identifier, associated with the package, the scannable identifier encoding the part-type of the parts contained in the package and a respective quantity of each part-type,
wherein the computer readable medium is further configured to scan the scannable identifier upon receipt of the package at the respective location.

12. The system of claim 11, wherein the computer readable medium is further configured to:
determine the received-quantity of each part-type received at the location;
compare the received-quantity of each part type to the total number of each part to be delivered to the respective location; and
produce a report regarding the results of the comparison.

13. The system of claim 12, wherein the computer readable medium is further configured to:
produce a discrepancy report identifying inconsistencies between the received-quantity of each part-type delivered and the total-quantity of each part-type to be delivered according to the materials request list for each respective location.

14. The system of claim 13, wherein the computer readable medium is further configured to resolve the inconsistencies identified in the discrepancy report.

15. The system of claim 11, wherein the scannable identifier comprises a bar code.

16. The system of claim 11, wherein the scannable identifier comprises an RFID tag.

17. The system of claim 10, wherein the computer readable medium is further configured to aggregate two or more of the plurality of orders on a predetermined schedule.

18. The system of claim 10, wherein the aggregation step is performed based on a predetermined schedule.

19. The system of claim 10, wherein each part is associated with a scannable identifier encoding manufacturing information concerning the part, and the computer readable medium is further configured to
scan the identifier associated with each part prior to delivery to the respective location; and
determine if manufacturing information satisfies a part alert
